(19) United States
(12) Patent Application Publication
(10) Pub. No.: US 2025/0256585 A1
(43) Pub. Date: Aug. 14, 2025

(54) ELECTRIFIED VEHICLE

(71) Applicant: TOYOTA JIDOSHA KABUSHIKI KAISHA, Toyota-shi (JP)

(72) Inventors: Satoshi SASAKI, Nagoya-shi (JP); Toshifumi YAMAKAWA, Okazaki-Shi (JP)

(73) Assignee: TOYOTA JIDOSHA KABUSHIKI KAISHA, Toyota-shi (JP)

(21) Appl. No.: 18/941,294

(22) Filed: Nov. 8, 2024

(30) Foreign Application Priority Data
Feb. 13, 2024 (JP) 2024-019512

(51) Int. Cl. B60L 15/08; B60L 3/10

(52) U.S. Cl. CPC B60L 15/08; B60L 3/106; B60L 2210/14; B60L 2210/40

(57) ABSTRACT

Electrified vehicle includes a motor connected to drive wheels, an inverter for driving the motor, a power storage device, a boost converter provided between the power storage device and the inverter, and a control device for controlling the inverter and the boost converter. When a predetermined condition is satisfied in which the inverter is controlled by pulse width modulation control and the absolute value of the torque command is equal to or greater than the threshold value, the control device sets the control cycle of the boost converter to be the same as the control cycle of the inverter.

### CROSS-REFERENCE TO RELATED APPLICATION

This application claims priority to Japanese Patent Application No. 2024-019512 filed on Feb. 13, 2024, incorporated herein by reference in its entirety.

### BACKGROUND

### 1. Technical Field

The present disclosure relates to an electrified vehicle.

### 2. Description of Related Art

Conventionally, an electrified vehicle has been proposed (for example, refer to Japanese Unexamined Patent Application Publication No. 2010-263719 (JP 2010-263719 A)), the electrified vehicle including a boost converter that boosts and outputs a voltage from a power storage device, an inverter that converts DC power from the boost converter into multi-phase AC power and outputs the multi-phase AC power, and a motor that is rotationally driven by the multi-phase AC power output from the inverter. In the electrified vehicle, when there is a requirement for a temperature rise control of the power storage device, and when a calculation value of an output voltage of the boost converter that is a minimum limit required for rotational driving of the motor is equal to or less than a temperature rise control voltage for the temperature rise control of the power storage device, the output voltage of the boost converter is set to the temperature rise control voltage, and a carrier frequency of the boost converter is set to a voltage rise control carrier frequency to increase the temperature of the power storage device. On the other hand, in this case, when the calculation value exceeds the temperature rise control voltage, the carrier frequency of the boost converter is set to a normal control carrier frequency, and the output voltage of the boost converter is set to the calculation value to avoid a temperature rise control.

### SUMMARY

In the electrified vehicle, when the inverter is controlled by a pulse width modulation (PWM) control and the torque of the motor is comparatively large, there may be cases in which control of the boost converter is comparatively largely disturbed due to a current ripple of a control cycle of the inverter at an output side (inverter side) of the boost converter, and a current ripple at an input side (power storage device side) of the boost converter becomes comparatively large.

An objective of the electrified vehicle of the present disclosure is to suppress a current ripple on a power storage device side of a boost converter from becoming comparatively large.

The electrified vehicle of the present disclosure adopts the following techniques in order to achieve the objective.

An electrified vehicle of the present disclosure includes a motor connected to a drive wheel, an inverter that drives the motor, a power storage device, a boost converter provided between the power storage device and the inverter, and a control device that controls the inverter and the boost converter based on a torque command of the motor.

When the control device controls the inverter by a pulse width modulation control, and a predetermined condition in which an absolute value of the torque command is equal to or more than a threshold is established, the control device sets a control cycle of the boost converter to be identical to a control cycle of the inverter.

In the electrified vehicle of the present disclosure, when the control device controls the inverter by a pulse width modulation control and a predetermined condition is established, the predetermined condition being an absolute value of the torque command is equal to or more than a threshold, the control device sets a control cycle of the boost converter to be identical to a control cycle of the inverter. As a result, control of the boost converter can be suppressed from being comparatively largely disturbed due to a current ripple of a control cycle of the inverter on an output side (inverter side) of the boost converter. As a result, a current ripple on an input side (power storage device side) of the boost converter can be suppressed from becoming comparatively large.

In the electrified vehicle of the present disclosure, the control device may control the inverter by the pulse width modulation control in a control cycle corresponding to twice a first carrier frequency and control the boost converter in a control cycle corresponding to a second carrier frequency, and when the predetermined condition is established, the control device may set the second carrier frequency to twice the first carrier frequency. In this case, when the control device controls the inverter by the pulse width modulation control using three-phase modulation, the control device may control the inverter in a control cycle corresponding to twice the first carrier frequency.

In the electrified vehicle of the present disclosure, the control device may control the inverter by the pulse width modulation control in a control cycle corresponding to twice a first carrier frequency and control the boost converter in a control cycle corresponding to a second carrier frequency, and when the predetermined condition is established, the control device may set the second carrier frequency to be identical to the first carrier frequency. In this case, when the control device controls the inverter by the pulse width modulation control using two-phase modulation, the control device may control the inverter in a control cycle corresponding to the first carrier frequency.

In the electrified vehicle of the present disclosure, when slippage due to idling of the drive wheel occurs, the control device may shorten a control cycle of the boost converter compared to when slippage due to idling of the drive wheel does not occur.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle 20 according to an embodiment of the present disclosure;

FIG. 2A is an explanatory diagram showing an embodiment of a state of generating a PWM of the phase voltage command Vu*, Vv*, Vw* and the transistor T11 of each phase when the inverter 34 is controlled by PWM control using three-phase modulations;

FIG. 2B is an explanatory diagram showing an embodiment of a state of generating a PWM of the phase voltage command Vu*, Vv*, Vw* and the transistor T11 of each phase when the inverter 34 is controlled by PWM control using three-phase modulations;

FIG. 3 is a flowchart illustrating an example of a processing routine repeatedly executed by the electronic control unit 50;

FIG. 4A is an explanatory diagram showing an exemplary aspect of generating PWM of the phase voltage command Vu*, Vv*, Vw* and the transistor T11 of each phase when the inverter 34 is controlled by PWM control using the two-phase modulation; and

FIG. 4B is an explanatory diagram showing an exemplary aspect of generating a PWM of the phase voltage command Vu*, Vv*, Vw* and the transistor T11 of each phase when the inverter 34 is controlled by PWM control using a two-phase modulation.

### DETAILED DESCRIPTION OF EMBODIMENTS

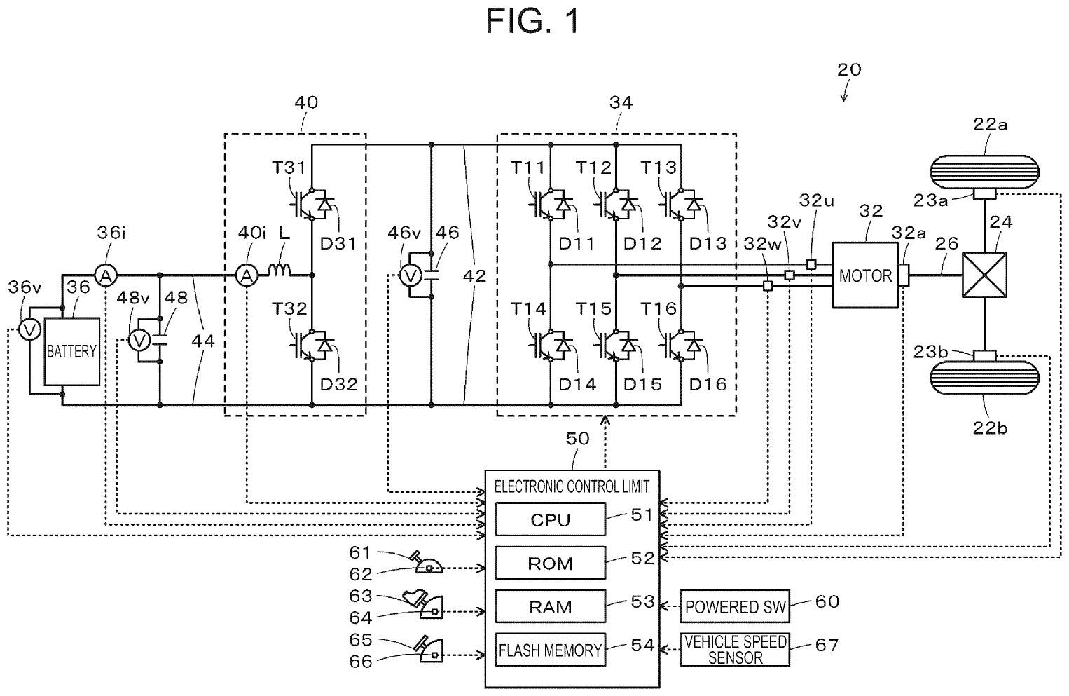

Embodiments for carrying out the present disclosure will be described with reference to the drawings. FIG. 1 is a schematic configuration diagram of a battery electric vehicle 20 according to an embodiment of the present disclosure. As illustrated in the drawing, battery electric vehicle 20 of the embodiment includes a motor 32, an inverter 34, a battery 36 as a power storage device, a boost converter 40, and an electronic control unit 50 as a control device.

The motor 32 is configured as a three-phase AC motor, and includes a rotor in which a permanent magnet is embedded in a rotor core, and a stator in which a three-phase coil is wound around the stator core. The rotor of the motor 32 is connected to a drive shaft 26 connected to the drive wheel 22a, 22b via a differential gear 24.

The inverter 34 is used to drive the motor 32 and is connected to the boost converter 40 via the high-voltage-side power line 42. The inverter 34 includes transistors T11 to T16 as six switching elements, and six diodes D11 to D16 connected in parallel to each of the six transistors T11 to T16. Transistor T11 to T16 are arranged in pairs of two so as to be source side and sink side with respect to the positive line and negative line of the high-voltage side power line 42, respectively. Each of the connecting points of the transistors which are the pair of the transistors T11 to T16 is connected to each of the three-phase (U-phase, V-phase, and W-phase) coils of the motor 32. Therefore, when a voltage is applied to the inverter 34, the electronic control unit 50 adjusts the ratio of the on-time of T16 from the pair of transistors T11, thereby forming a rotating magnetic field in the three-phase coil of the motor 32 and rotationally driving the motor 32 (rotor). A smoothing capacitor 46 is attached to the positive line and the negative line of the high-voltage-side power line 42.

The battery 36 is configured as, for example, a lithium-ion secondary battery or a nickel-hydrogen secondary battery, and is connected to the boost converter 40 via the low-voltage-side power line 44. A smoothing capacitor 48 is attached to the positive line and the negative line of the low-voltage-side power line 44.

The boost converter 40 is connected to the high-voltage-side power line 42 and the low-voltage-side power line 44, and includes a transistor T31, T32 as two switching elements, two diode D31, D32 connected in parallel to each of the two transistor T31, T32, and a reactor L. The transistor T31 is connected to the positive line of the high-voltage-side power line 42. The transistor T32 is connected to the transistor T31 and the negative line of the high-voltage-side power line 42 and the negative line of the low-voltage-side power line 10 44. The reactor L is connected to the connecting points of the two transistors T31, T32 and the positive line of the low-voltage-side power line 44. As the ratio of an “on” time of the transistors T31, T32 is adjusted by the electronic control unit 50, the boost converter 40 raises the voltage of electricity in the low voltage-side power lines 44 and supplies this electricity to the high voltage-side power lines 42, or lowers the voltage of electricity in the high voltage-side power lines 42 and supplies this electricity to the low voltage-side power lines 44.

The electronic control unit 50 includes a microcomputer having a CPU 51, ROM 52, RAM 53, a flash memory 54, an input and output port, and a communication port.

The electronic control unit 50 receives signals from various sensors via input ports. For example, the electronic control unit 50 receives the rotational speed Nwa, Nwb from the rotational speed sensor 23a, 23b attached to the drive wheel 22a, 22b. The electronic control unit 50 also receives the rotational position θm from the rotational position sensor 32a for detecting the rotational position of the rotor of the motor 32, and the phase current Iu, Iv, Iw from the current sensor 32u, 32v, 32w for detecting the phase current of each phase of the 25 motor 32. The electronic control unit 50 also receives a voltage Vb from a voltage sensor 36v mounted between terminals of the battery 36 and a current Ib from a current sensor 36i mounted at an output terminal of the battery 36. The electronic control unit 50 also receives a current IL from a current sensor 40i mounted in series with the reactor L of the boost 30 converter 40, a voltage VH of a capacitor 46 (high-voltage-side power line 42) from a voltage sensor 46v mounted between terminals of the capacitor 46, and a voltage VL of a capacitor 48 (low-voltage-side power line 44) from a voltage sensor 48v mounted between terminals of the capacitor 48. The electronic control unit 50 also receives a start signal from the power switch 60, a shift position SP from the shift sensor 62 for detecting the operation position of the shift lever 61, an accelerator operation amount Acc from the accelerator pedal position sensor 64 for detecting the depression amount of the accelerator pedal 63, a brake pedal position BP from the brake pedal position sensor 66 for detecting the depression amount of the brake pedal 65, and a vehicle speed V from the vehicle speed sensor 67.

The electronic control unit 50 outputs various control signals via an output port. For example, the electronic control unit 50 outputs a control signal from the transistor T11 to T16 of the inverter 34 and a control signal to the transistor T31, T32 of the boost converter 40. The electronic control unit 50 calculates the electric angle θe and the rotational speed Nm of the motor 32 based on the rotational position Om of the rotor of the motor 32 from the rotational position sensor 32a. The electronic control unit 50 calculates the power storage ratio SOC of the battery 36 based on the integrated value of the current Ib of the battery 36 from the current sensor 36i.

In battery electric vehicle 20 of the embodiment configured in this way, the electronic control unit 50 (CPU 51) sets the required torque Td* required for the drive shaft 26 based on the accelerator operation amount Acc and the vehicle speed V, sets the set required torque Td* to the torque command Tm* of the motor 32 so as to be outputted to the drive shaft 26, and performs the switching control of the transistor T31,T32 of the boost converter 40 and the switching control of T16 from the transistor T11 of the inverter 34 based on the torque command Tm *.

The electronic control unit 50 controls the inverters 34 by pulse-width modulation (PWM) control or square-wave control based on the modulation factor Rm. Here, the modulation factor Rm is defined as the ratio of the effective value of the output voltage (the applied voltage of the motor 32) to the input voltage of the inverter 34 (the voltage VH of the high-voltage-side power line 42). Instead of the modulation factor Rm, PWM control or the square-wave control may be selected based on the torque command Tm* and the rotational speed Nm. Hereinafter, PWM control will be described. Since the rectangular wave control is not the core of the present disclosure, a detailed description thereof will be omitted.

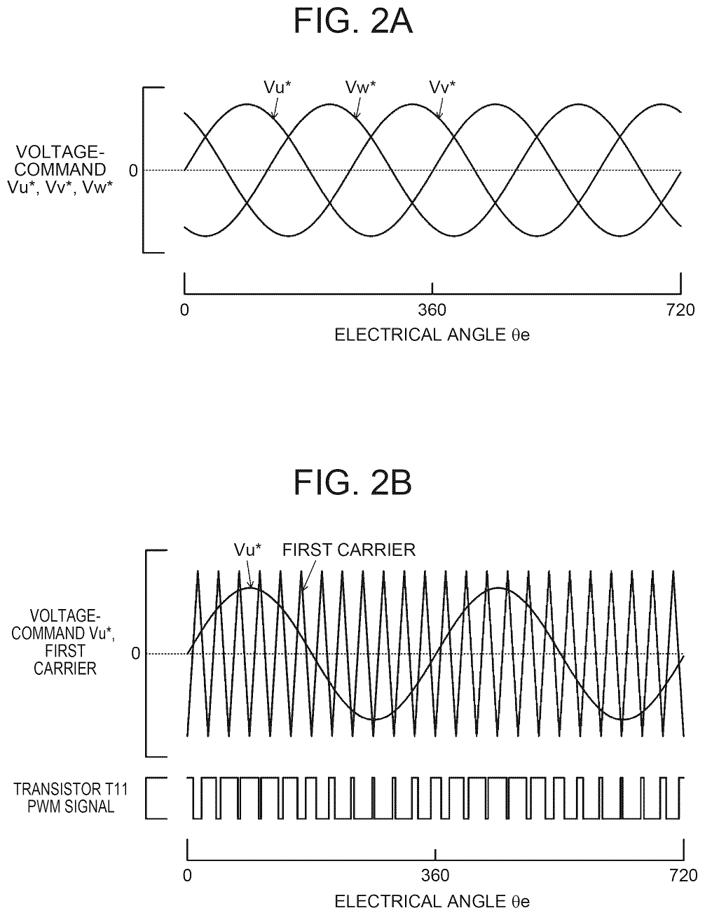

In PWM control, the electronic control unit 50 generates the PWM signal from the transistors T11 to T16 using a first PWM signal generating process, and performs the switching control from the transistors T11 to T16 using the generated PWM signal from the transistors T11 to T16. In the first PWM signal-generating process, the phase current Iu,Iv,Iw of each phase of the motor 32 is coordinate-transformed (three-phase-two-phase transformation) using the electric angle θe of the motor 32 to calculate the current Id, Iq of the d-axis and the q-axis. Subsequently, the current command Id*, Iq* of the d-axis and the q-axis is set based on the torque command Tm* of the motor 32. Then, the d-axis, the difference between the current Id,Iq and the current command Id*, Iq* of the q-axis is canceled by the current feedback control d-axis, calculates the voltage command Vd*, Vq* of the q-axis, the calculated d-axis, the voltage command Vd*, Vq* of the q-axis coordinate conversion by three-phase modulation using the electric angle θe of the motor 32 (2-3-phase conversion) to calculate the phase voltage command Vu*, Vv*, Vw* of each phase. PWM of T16 is generated from the transistor T11 by using the phase-voltage command Vu*, Vv*, Vw* of each phase and the first carrier wave (triangular wave) of the first carrier frequency fa obtained in this manner. As the first carrier frequency fa, for example, a 2.5 kHz to 5 kHz degree is used. FIGS. 2A and 2B are explanatory diagrams illustrating an exemplary manner of generating the phase-voltage command Vu*, Vv*, Vw* of each phase and PWM of the transistor T11 when the inverter 34 is controlled by PWM control using two-phase modulation. FIG. 2A shows the phase-voltage command Vu*, Vv*, Vw* of each phase, FIG. 2B shows how to generate PWM of the transistor T11. In the embodiment, the first PWM signal generating process is executed at timings of peaks and valleys of the first carrier wave, that is, at a control cycle (1/(2·fa)) corresponding to twice the first carrier frequency fa.

In the control of the boost converter 40, the electronic control unit 50 generates a second PWM signal generating process to generate the transistor T31,T32's PWM signal, and performs the switching control of the transistor T31, T32 using the generated PWM signal of the transistor T31, T32. In the second PWM signal generating process, first, the target voltage VHtag of the high-voltage-side power line 42 is set based on the torque command Tm* and the rotational speed Nm of the motor 32, and the target current ILtag of the reactor L is calculated by the voltage feedback control so that the difference between the voltage VH of the high-voltage-side power line 42 and the target voltage VH* is canceled out. Subsequently, the duty command D* is calculated by the current feedback control so that the difference between the current IL of the reactor L and the target current IL* is canceled out, and PWM of the transistor T31, T32 is generated using the calculated duty command D* and the second carrier wave (triangular wave) of the second carrier frequency fb. In the embodiment, the second PWM generating process is executed at the timings of peaks or valleys of the second carrier wave, that is, at the control cycle (1/fb) corresponding to the second carrier frequency fb.

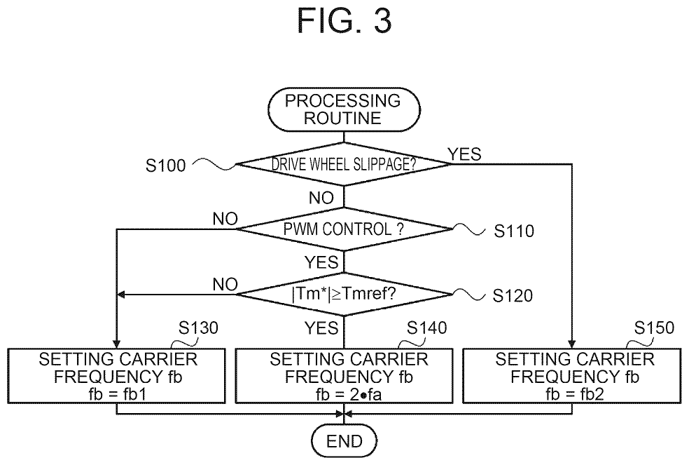

Next, the operation of battery electric vehicle 20 according to the embodiment, in particular, the setting process of the second carrier frequency fb will be described. FIG. 3 is a flow chart illustrating an exemplary process routine that is repeatedly executed by the electronic control unit 50 (CPU 51).

When the process of FIG. 3 is executed, the electronic control unit 50 first determines whether the drive wheel 22a, 22b slippage occurs due to idling (S100). This determination process can be performed, for example, by comparing the rotational speed change rates ΔNwa and ΔNwb, which are changes in the rotational speed Nwa, Nwb of the drive wheel 22a, 22b per unit time, with the thresholds ΔNwref. It should be noted that the rotation speed change rate ΔNm, which is a change amount of the rotational speed Nm of the motor 32 per unit time, may be compared with the threshold value ΔNmref.

When the electronic control unit 50 determines that slippage due to idling of the drive wheel 22a, 22b has not occurred in S100, it determines which of PWM control and the square-wave control the inverter 34 is controlling (S110), and determines whether or not the absolute value of the torque command Tm* of the motor 32 is equal to or greater than the threshold Tmref (S120). S110, S120 process is a process of determining whether or not there is a possibility that the control of the boost converter 40 is disturbed relatively greatly by the current ripple of the control cycle (1/(2.fa)) of the inverter 34 at the output side of the boost converter 40 (the inverter 34 side), and the current ripple at the input side of the boost converter 40 (the battery 36 side) becomes relatively large.

Electronic control unit 50, when it is determined that the inverter 34 is controlled by the rectangular wave control in S110, or when it is determined that the absolute value of the torque command Tm* of the motor 32 in S120 is less than the threshold Tmref, the input side of the boost converter 40 (battery 36 side) current ripple is determined to be relatively low, set a predetermined frequency fb1 to the second carrier frequency fb (S130), the routine ends. Here, as the predetermined frequency fb1, for example, a 10 kHz to a 15 kHz degree is used.

The electronic control unit 50 determines that the inverter 34 is controlled by PWM control in S110, and when S120 determines that the absolute value of the torque command Tm* of the motor 32 is equal to or larger than the threshold Tmref, it determines that there is a possibility that the current ripple on the input side (the battery 36 side) of the boost converter 40 is relatively large, sets the frequency twice the first carrier frequency fa in the second carrier frequency fb (S140), and ends the routine. That is, the control cycle (1/fb) of the boost converter 40 is the same as the control cycle (1/(2·fa)) of the inverter 34. As a result, it is possible to suppress the control of the boost converter 40 from being disturbed by the current ripple of the control cycle (1/(2·fa)) of the inverter 34 at the output side of the boost converter 40 (the inverter 34 side). As a result, it is possible to suppress the current ripple on the input side (the battery 36 side) of the boost converter 40 from becoming relatively large. The inventors also confirmed this by analysis and experiments.

When the electronic control unit 50 determines that slippage due to idling of the drive wheel 22a, 22b has occurred in S100, a predetermined frequency fb2 higher than the predetermined frequency fb1 is set in the second carrier frequency fb (S150), and the routine ends. That is, when slippage due to idling of the drive wheel 22a, 22b is occurring, the control cycle (1/fb) of the boost converter 40 is made shorter than when slippage due to idling of the drive wheel 22a, 22b is not occurring. Thus, the control stability of the boost converter 40 can be ensured. As the predetermined frequency fb2, for example, a value larger than the predetermined frequency fb1 by several kHz to about 10 kHz is used.

In battery electric vehicle 20 of the above-described embodiment, when the drive wheel 22a, 22b does not slippage due to idling and the inverter 34 is controlled by PWM control and the absolute value of the torque command Tm* of the motor 32 is equal to or larger than the threshold Tmref, the control cycle (1/fb) of the boost converter 40 is made equal to the control cycle (1/(2·fa)) of the inverter 34. As a result, it is possible to suppress the control of the boost converter 40 from being disturbed by the current ripple of the control cycle (1/(2.fa)) of the inverter 34 at the output side of the boost converter 40 (the inverter 34 side). As a result, it is possible to prevent the current ripple on the input side (the battery 36 side) of the boost converter 40 from becoming relatively large.

In the above-described embodiment, the electronic control unit 50 executes the first PWM signal generating process at the timings of the peaks and valleys of the first carrier wave, that is, at the control cycle (1/(2·fa)) corresponding to twice the first carrier frequency fa, but is not limited thereto. For example, the first PWM signal generating process may be performed at a peak timing or a valley timing of the first carrier wave, that is, at a control cycle (1/fa) corresponding to the first carrier frequency fa. In this case, when the drive wheel 22a, 22b does not slippage due to idling and the inverter 34 is controlled by PWM control and the absolute value of the torque command Tm* of the motor 32 is equal to or larger than the threshold Tmref, the control cycle (1/fb) of the boost converter 40 may be made equal to the control cycle (1/fa) of the inverter 34 by setting the first carrier frequency fa in the second carrier frequency fb.

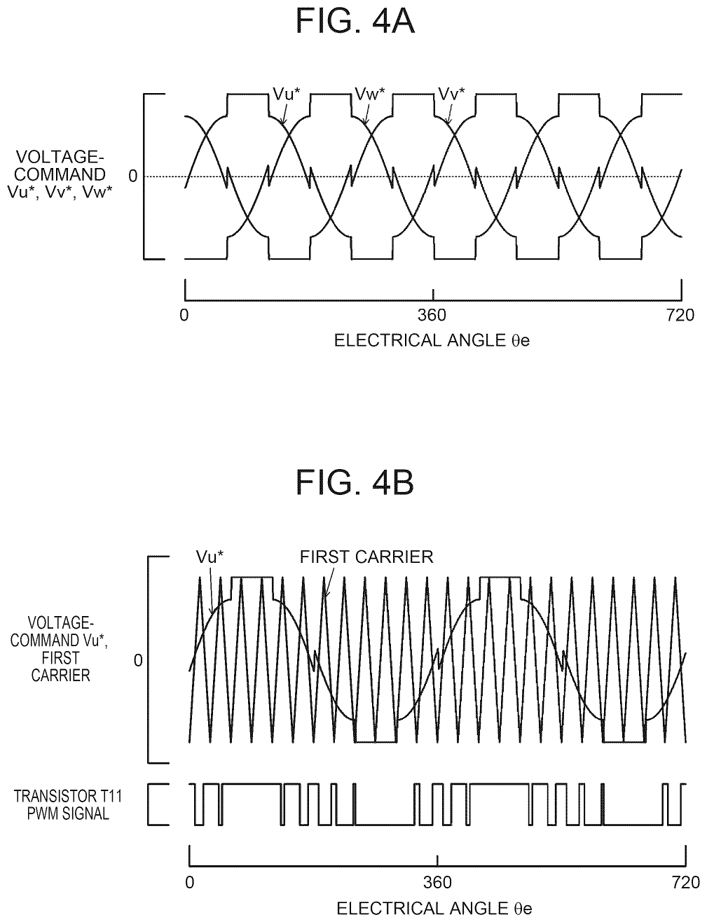

In the above-described embodiment, the electronic control unit 50 controls the inverters 34 by PWM control using three-phase modulations, but the present disclosure is not limited thereto. For example, the inverters 34 may be controlled by PWM control using two-phase modulations. In this case, in the first PWM signal generating process, in place of calculating the phase voltage command Vu*, Vv*, Vw* of each phase by coordinate conversion of the voltage command Vd*, Vq* of the d-axis, q-axis (2-phase-3-phase conversion) by three-phase modulation using the electric angle θe of the motor 32, the phase voltage command Vu*, Vv*, Vw* of each phase is calculated by coordinate conversion of the voltage command Vd*, Vq* of the d-axis, q-axis (2-phase-3-phase conversion) by two-phase modulation using the electric angle θe of the motor 32. FIGS. 4A and 4B are explanatory diagrams illustrating an exemplary manner of generating the phase-voltage command Vu*, Vv*, Vw* of each phase and PWM of the transistor T11 when the inverter 34 is controlled by PWM control using two-phase modulation. FIG. 4A shows the phase-voltage command Vu*, Vv*, Vw* of each phase, FIG. 4B shows how to generate PWM of the transistor T11. When the inverter 34 is controlled by PWM control using two-phase modulation, the first PWM signal generating process may be executed at the control cycle corresponding to twice the first carrier frequency fa (1/(2·fa)), or the first PWM signal generating process may be executed at the control cycle corresponding to the first carrier frequency fa (1/fa). In either case, when the drive wheel 22a, 22b is not slippage due to idling and the inverter 34 is controlled by PWM control and the absolute value of the torque command Tm* of the motor 32 is equal to or larger than the threshold Tmref, the control cycle (1/fb) of the boost converter 40 may be the same as the control cycle (1/(2 fa) or 1/fa) of the inverter 34.

In the above-described embodiment, the electronic control unit 50 controls the inverters 34 by PWM control using three-phase modulations. In the above-described modification, the electronic control unit 50 controls the inverters 34 by PWM control using two-phase modulations. In general, the three-phase modulation can improve the controllability of the inverter 34 as compared with the two-phase modulation. On the other hand, the two-phase modulation can reduce the switching-loss of T16 from the transistor T11 of the inverter 34 as compared with the three-phase modulation. Therefore, three-phase modulation or two-phase modulation may be selected based on the temperature of the inverter 34 or the like.

In the above-described embodiment, the electronic control unit 50 sets the predetermined frequency fb1 to the second carrier frequency fb when the inverter 34 is controlled by the square-wave control or when the absolute value of the torque command Tm* of the motor 32 is less than the threshold Tmref when the slippage due to idling of the drive wheel 22a, 22b is not occurring. Further, the electronic control unit 50 sets the second carrier frequency fb to a predetermined frequency fb2 higher than the predetermined frequency fb1 when slippage due to idling of the drive wheel 22a, 22b occurs. However, the same frequency may be used as the predetermined frequency fb1 and the predetermined frequency fb2.

In the above-described embodiment, the battery 36 is used as the power storage device, but the present disclosure is not limited thereto. For example, a capacitor or the like may be used as the power storage device.

In the above-described embodiment, the configuration of battery electric vehicle 20 including the motor 32, the inverter 34, the battery 36, and the boost converter 40 has been described, but the configuration is not limited thereto. For example, in addition to a hardware configuration similar to that of battery electric vehicle 20, a hybrid electric vehicle configuration including an engine may be employed, or a fuel cell electric vehicle configuration including a fuel-cell in addition to a hardware configuration similar to that of battery electric vehicle 20 may be employed. For hybrid electric vehicle configurations, the drive shaft connected to the first motor and the engine and the drive wheel may be connected to the sun gear and the carrier and the ring gear of the planetary gear respectively, a second motor may be connected to the drive shaft, and a boost converter may be provided between the first, second inverters for driving the first, second motors respectively and the battery Further, a boost converter may be provided between an inverter that drives a motor and a battery by connecting a motor to a drive shaft connected to the drive wheels via a transmission and connecting an engine to the motor via a clutch.

The correspondence between the main elements of the embodiments and the main elements of the disclosure described in the column of the means for solving the problem will be described. In the embodiment, the motor 32 corresponds to the “motor”, the inverter 34 corresponds to the “inverter”, the battery 36 corresponds to the “power storage device”, the boost converter 40 corresponds to the “boost converter”, and the electronic control unit 50 corresponds to the “control device”.

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of an electrified vehicle and the like.

What is claimed is:

1. An electrified vehicle comprising:
a motor connected to a drive wheel;
an inverter that drives the motor;
a power storage device;
a boost converter provided between the power storage device and the inverter; and
a control device that controls the inverter and the boost converter based on a torque command of the motor, wherein when the control device controls the inverter by a pulse width modulation control, and a predetermined condition in which an absolute value of the torque command is equal to or more than a threshold is established, the control device sets a control cycle of the boost converter to be identical to a control cycle of the inverter.

2. The electrified vehicle according to claim 1, wherein
the control device controls the inverter by the pulse width modulation control in a control cycle corresponding to twice a first carrier frequency and controls the boost converter in a control cycle corresponding to a second carrier frequency, and
when the predetermined condition is established, the control device sets the second carrier frequency to twice the first carrier frequency.

3. The electrified vehicle according to claim 1, wherein
the control device controls the inverter by the pulse width modulation control in a control cycle corresponding to a first carrier frequency and controls the boost converter in a control cycle corresponding to a second carrier frequency, and
when the predetermined condition is established, the control device sets the second carrier frequency to be identical to the first carrier frequency.

4. The electrified vehicle according to claim 1, wherein
when slippage due to idling of the drive wheel occurs, the control device shortens a control cycle of the boost converter compared to when slippage due to idling of the drive wheel does not occur.
